(19) United States
(12) Patent Application Publication
(10) Pub. No.: US 2011/0207648 A1
(43) Pub. Date: Aug. 25, 2011

(54) Use Of N,N-Bis(2-Hydroxyethyl)Cocoamine Oxide For The Cleaning Of Hard Surfaces

(75) Inventors: Matthias LOEFFLER, Idstein (DE); Daniel Stephen ROCQUE, Cornelius, NC (US); George Italo Pitombeira NUNES, Huntersville, NC (US)

(73) Assignee: CLARIANT INTERNATIONAL LTD., Muttenz (CH)

(21) Appl. No.: 12/711,528

(22) Filed: Feb. 24, 2010

(51) Int. Cl. C11D 1/75

(52) U.S. Cl. 510/238; 510/109; 510/244

(57) ABSTRACT

The use of compositions comprising N,N-bis(2-hydroxyethyl)cocoamine oxide for the cleaning of hard surfaces consisting of materials selected from ceramic, metal, wood, glass and plastic from lime-containing soil is described.

The present invention relates to the use of N,N-bis(2-hydroxyethyl)-cocoamine oxide for the cleaning of hard surfaces from lime-containing soil.

Numerous compositions are already known which can be used for the cleaning of hard surfaces. However, the cleaning effect for eliminating lime-containing deposits is often unsatisfactory. Compositions which have a good lime-dissolving ability are often very aggressive towards the surfaces to be cleaned.

It was therefore the object to provide compositions which on the one hand have very good detergency toward hard surfaces consisting of materials selected from ceramic, metal, wood, glass and plastic that are contaminated with lime-containing soil and, on the other hand, do not attack even sensitive materials.

Surprisingly, it has been found that this object is achieved by compositions comprising N,N-bis(2-hydroxyethyl)cocoamine oxide.

The present invention therefore provides the use of a composition comprising N,N-bis(2-hydroxyethyl)cocoamine oxide for the cleaning of hard surfaces consisting of materials selected from ceramic, metal, wood, glass and plastic from lime-containing soil, preferably in the sanitary sector.

U.S. Pat. No. 3,324,183 describes N,N-bis(2-hydroxyethyl)alkylamine oxides with long-chain alkyl radicals, such as, for example, N,N-bis(2-hydroxyethyl)-cocoamine oxide, their preparation and also their advantageous foaming ability in liquid compositions for the cleaning of textiles and dishes.

However, both in the case of textiles and also in the case of dishes, the soilings which normally arise are not lime-containing soil.

The compositions used in the use according to the invention are also referred to below as “composition A” or as “compositions A”.

The compositions A have high storage stability, in particular high stability of hydrolysis-sensitive components present therein. They are safe to handle and, moreover, are skin-friendly and environmentally compatible. It is also advantageous that they can be formulated with a clear appearance and colorless.

Preferably, the use according to the invention is for the cleaning of hard surfaces consisting of materials selected from plastic and ceramic and particularly preferably for the cleaning of hard surfaces made of ceramic. Particularly preferably, the use according to the invention is for the cleaning of floor and wall tiles, washbasins, toilets, and also shower and bath tubs.

Within the context of this invention, lime-containing soil is to be understood as meaning soil which contains lime, and in addition may also contain other types of soil. These other types of soil may be, for example, soap residues, oily soilings, soilings resulting from rubber scuffing, soot or dust. However, the lime-containing soil can also consist of 100% by weight of lime.

The lime-containing soil preferably comprises 5 to 100% by weight of lime.

In one particularly preferred embodiment of the invention, the lime-containing soil comprises 10 to 90% by weight, preferably 20 to 85% by weight, particularly preferably 30 to 80% by weight and especially preferably 50 to 80% by weight of lime.

In a further particularly preferred embodiment of the invention, the lime-containing soil consists of lime.

Preferably, the cocoyl radical of the N,N-bis(2-hydroxyethyl)cocoamine oxide present in the compositions A comprises from 40 to 60% by weight of C₁₂-hydrocarbon radicals and from 10 to 30% by weight of C₁₄-hydrocarbon radicals, based on the total cocoyl radical.

The compositions A are characterized in that, even at low concentrations of N,N-bis(2-hydroxyethyl)cocoamine oxide, they achieve a very good cleaning effect. Compared to many conventional cleaning compositions comprising customarily used active substances, therefore, a comparable cleaning effect can be achieved with significantly lower concentrations of N,N-bis(2-hydroxyethyl)cocoamine oxide in the compositions A.

Preferably, the compositions A comprise from 0.1 to 20% by weight, preferably from 0.1 to 10% by weight, particularly preferably from 0.2 to 5% by weight and especially preferably from 0.3 to 1.5% by weight, of N,N-bis(2-hydroxyethyl)cocoamine oxide.

N,N-bis(2-Hydroxyethyl)cocoamine oxide is notable in the compositions A for good compatibility with other components and can be incorporated very easily into compositions of highly diverse consistency, such as, for example, into liquid, sprayable, solid or pasty compositions.

In one preferred embodiment of the invention, the compositions A are liquid at room temperature. Moreover, these liquid compositions A can be used according to the invention in an advantageous manner in sprayable form. In one particularly preferred embodiment of the invention, the compositions A are therefore present in sprayable form at room temperature.

In a further preferred embodiment of the invention, the compositions A are solid or pasty at room temperature. The term “pasty” has the customary meaning and, within the context of the present invention, means in particular that the corresponding composition does not flow at room temperature but can nevertheless be molded easily by hand. The solid or pasty compositions are preferably dissolved in water prior to their use.

Furthermore, the compositions are also stable in an acidic medium, in particular at a pH≦5, and are particularly effective in the presence of acids.

In a further preferred embodiment of the invention, the liquid compositions A or the solid or pasty compositions A dissolved in water have a pH of pH≦5.

In a further preferred embodiment, the compositions A comprise one or more acids.

Of suitability are organic or inorganic acids, preferably organic acids, particularly preferably fruit acids selected from malic acid, fumaric acid, gluconic acid, glycolic acid, mandelic acid, lactic acid, oxalic acid, salicylic acid, alpha-hydroxycaprylic acid, tartaric acid and citric acid. Furthermore, acids selected from ascorbic acid, benzoic acid, pyruvic acid, acetic acid, fumaric acid and maleic acid are preferably used.

The compositions A can comprise the one or more acids preferably in amounts of from 0.1 to 10.0% by weight, particularly preferably from 0.5 to 8.0% by weight, and especially preferably from 1.0 to 5.0% by weight.

In a further preferred embodiment of the invention, the liquid compositions A or the solid or pasty compositions A dissolved in water have a pH of >5 to 11.

In a further preferred embodiment of the invention, the compositions A comprise one or more substances selected from disinfectants and bleaches.

Within the context of the present invention, disinfectants and bleaches which can be used are, for example, chlorine- or bromine-releasing substances or organic or inorganic peroxides.

Among the suitable chlorine- or bromine-releasing materials, for example, heterocyclic N-bromoamides and N-chloroamides, for example trichloroisocyanuric acid, tribromoisocyanuric acid, dibromoisocyanuric acid and/or dichloroisocyanuric acid (DICA) and/or salts thereof with cations such as potassium and sodium are suitable. Hydantoin compounds, such as 1,3-dichloro-5,5-dimethylhydantoin, are likewise suitable.

Anhydrous, water-soluble inorganic salts are likewise suitable as bleaches, thus, e.g. lithium, sodium or calcium hypochlorite and hypobromite. Chlorinated trisodium phosphate is likewise suitable.

Suitable organic peroxides are, for example, organic peracids and diacyl peroxides, for example peroxybenzoic acid and their analogs substituted on the benzene ring, aliphatic and substituted aliphatic monoperoxy acids, for example peroxylauric acid or peroxystearic acid, alkyldiperoxy acids and aryldiperoxy acids such as 1,12-diperoxydodecanoic acid, 1,9-diperoxybrassidylic acid, diperoxysebacylic acid, diperoxyisophthalic acid, and also dibenzoyl peroxide.

The inorganic peroxy compounds which can be used within the context of the present invention include, for example, monopersulfates, perborates and percarbonates. The inorganic peroxy compounds are usually used as alkali metal salts, preferably as lithium, sodium or potassium salts.

A disinfectant that can be used is e.g. also benzisothiazolinone, e.g. in the commercially available form of Nipacide BIT 20 (Clariant), which is a ca. 20% strength by weight glycolic solution of benzisothiazolinone.

Further preferred disinfectants are also quaternary ammonium compounds, such as, for example, C_{12/14}-alkyldimethylbenzylammonium chloride.

The compositions A can comprise the disinfectants and bleaches in amounts of from preferably 0.001 to 10% by weight, particularly preferably from 0.01 to 5% by weight and especially preferably from 0.02 to 2% by weight.

The compositions A can advantageously be supplied in phosphate-free form and, in this form, are particularly environmentally friendly and do not pollute rivers and streams.

In a further preferred embodiment of the invention, the compositions A are therefore phosphate-free.

The compositions A can be adjusted in a simple manner to a viscosity greater than 100 mPa·s at room temperature, e.g. with the help of customary thickeners. The viscosities of the compositions A are retained even in the case of temperature fluctuations in the range from 0 to 40° C. and even in the case of a long storage time. These compositions A on the one hand afford the advantage that the viscosification prevents a “spraying” of the composition and safer use is thereby ensured. Moreover, the increased viscosity provides for slower run-off of the compositions A from the surfaces and thus guarantees a longer action time. Improved effectiveness specifically toward lime deposits can thereby be achieved.

The compositions A can be in the form of aqueous, aqueous/organic, in particular aqueous/alcoholic, and organic formulations. Further embodiments may be: emulsions, dispersions, gels and suspensions.

Besides their cleaning effect, the compositions A can at the same time also have a disinfecting effect.

Possible fields of use according to the invention are, for example, bath cleaners, glass cleaners, floor cleaners, neutral cleaners and liquid all-purpose cleaners, for example in the sanitary sector.

Besides the possible ingredients already specified, the compositions A can also comprise surfactants of a nonionic, anionic, cationic or amphoteric nature, and also further customary auxiliaries and additives in varying amounts.

Nonionic surfactants which can be used are all customary nonionic surfactants, for example fatty alcohol alkoxylates, such as, for example, fatty alcohol ethoxylates.

Furthermore, semipolar nonionic surfactants, for example amine oxides which are different to N,N-bis(2-hydroxyethyl)cocoamine oxide, can be used, for example C₁₀-C₁₈-alkyldimethylamine oxides and C₈-C₁₂-alkoxy-ethyl dihydroxyethylamine oxides.

Suitable anionic surfactants are primarily straight-chain and branched alkyl sulfates, alkylsulfonates, alkyl carboxylates, alkyl phosphates, alkyl ester sulfonates, arylalkylsulfonates, alkyl ether sulfates and mixtures of said compounds. Further suitable anionic surfactants are olefinsulfonates, sulfonated polycarboxylic acids, alkylglycerol sulfates, fatty acyl glycerol sulfates, alkyl ether phosphates, isethionates, N-acyltaurides, alkyl succinamates and sulfosuccinates.

Examples of amphoteric surfactants which can be used in the compositions A are primarily alkyldimethylbetaines, alkylamidobetaines and alkyldipoly-ethoxybetaines. These compounds are marketed e.g. by Clariant under the trade name Genagen® CAB.

Further examples of surfactants that can be used within the context of the present invention are described e.g. in “Surface Active Agents and Detergents” (Vol. I and II, Schwartz, Perry and Berch).

Suitable further customary auxiliaries and additives are, for example, solvents, enzymes, thickeners, preservatives, fragrances and dyes and/or pearlizing agents.

In principle, suitable organic solvents are all mono- or polyhydric alcohols. Preference is given to using alcohols having 1 to 4 carbon atoms, such as methanol, ethanol, propanol, isopropanol, straight-chain and branched butanol, glycerol and mixtures of said alcohols. Further preferred alcohols are polyethylene glycols with a relative molecular mass below 2000. In particular, a use of polyethylene glycol with a relative molecular mass of from 200 to 600 in amounts up to 50% by weight is preferred. Further suitable solvents are, for example, triacetin (glycerol triacetate) and 1-methoxy-2-propanol.

Suitable enzymes are those from the class of proteases, lipases, amylases or mixtures thereof. Their fraction can be 0.2 to 1% by weight. The enzymes can be adsorbed to carrier substances and/or embedded in coating substances.

Thickeners which can be used are preferably hydrogenated castor oil, salts of long-chain fatty acids, preferably in amounts of from 0.1 to 5% by weight and particularly preferably in amounts of from 0.5 to 2% by weight, for example sodium, potassium, aluminum, magnesium and titanium stearates or the sodium and/or potassium salts of behenic acid, and also polysaccharides, in particular xanthan gum, guar guar, agar agar, alginates and tyloses, carboxymethylcellulose and hydroxyethylcellulose, and also relatively high molecular weight polyethylene glycol mono- and diesters of fatty acids, polyacrylates, polyvinyl alcohol and polyvinylpyrrolidone. Also suitable as thickeners are copolymers based on acryloyldimethyltauric acid.

Suitable preservatives are, for example, phenoxyethanol, formaldehyde solution, parabens, pentanediol or sorbic acid.

Fragrances which can be used are all substances that can customarily be used for this purpose, for example natural or synthetic substances of the ester type, ether type, aldehyde type, ketone type, alcohol type or hydrocarbon type, and also perfume oils, for example citrus oil.

Dyes which can be used are all substances that can customarily be used for this purpose. Particularly preferred dyes are water-soluble acid dyes, for example Acid Yellow 3 (CI 47005), Acid Yellow 23 (CI 19140), Acid Red 18 (CI 16255), Acid Blue 9 (CI 42090), Acid Blue 3 (CI 42051), Acid Red 249 (CI 18134), Acid Red 52 (CI 45100), Acid Blue 80 (CI 61585), Acid Green 25 (CI 61570). Likewise preferably used are also water-soluble direct dyes, for example Direct Yellow 28 (CI 19555), Direct Blue 199 (CI 74190) and water-soluble reactive dyes, for example Food Yellow 3 (CI 15985).

Suitable pearlizing agents are, for example, glycol distearic acid esters, such as ethylene glycol distearate, but also fatty acid monoglycol esters.

The compositions A are usually adjusted to a pH in the range from pH 1 to 12. In one preferred embodiment of the invention, the compositions A have a pH from pH 2.1 to 5. In a further preferred embodiment of the invention, the compositions A have a pH from pH 5.1 to 11.

The compositions usable in the use according to the invention can also be used for removing types of soil other than lime-containing soil from hard surfaces, this being, for example, oily soil, greasy soil, loamy soil and earthy soil, starch-containing soil or colored soilings.

The compositions A, in particular those compositions A that are liquid at room temperature, are typically applied directly onto the soiled surface. In case the compositions A are e.g. solid or pasty at room temperature they are preferably dissolved in water prior to their use. The application onto the surface can be done by spraying or by using a sponge or a fabric, typically followed by rubbing the treated area. The application and rubbing can be repeated as needed. The compositions A can be used as leave-on compositions, requiring no additional rinsing step. Alternatively, the compositions A can be washed off the cleaned surface after standing for some minutes.

The examples below are intended to illustrate the invention in detail without, however, limiting it thereto. Unless explicitly stated otherwise, all of the percentages are percentages by weight (% by wt.).

Examples of compositions A which can be used according to the invention:

Example 1-All-purpose cleaner

| | | % by wt. |
|---|---|---|
| A) | Ethoxylated tallow fatty amine, 12 EO (100% a.m.) | 3.2 |
| | (Genamin ® T120); a.m. = active matter | |
| B) | N,N-bis(2-hydroxyethyl)cocoamine oxide | 1.2 |
| C) | Water | ad 100 |
| D) | Fragrance | q.s. |
| E) | Dye | q.s. |
| F) | Preservative | q.s. |

Preparation Method:

I Mixing of A and C at room temperature with stirring

II Addition of B to I with stirring

III Addition of D, E and F to II with stirring

Example 2-All-purpose cleaner

| | | % by wt. |
|---|---|---|
| A) | C₁₀/C₁₈-fatty alcohol ethoxylate, 7 EO (100% a.m.) | 0.7 |
| | (Genapol ® C070) | |
| B) | N,N-bis(2-hydroxyethyl)cocoamine oxide | 0.5 |
| C) | Propylene glycol n-butyl ether (Dowanol PnB ®) | 0.5 |
| D) | Water | ad 100 |
| E) | Fragrance | q.s. |
| F) | Dye | q.s. |
| G) | Preservative | q.s. |

Preparation Method:

I Mixing of A and D at room temperature with stirring

II Addition of B to I with stirring

III Addition of C to II with stirring

IV Addition of E, F and G to HI with stirring

Example 3-All-purpose cleaner

| | | % by wt. |
|---|---|---|
| A) | C₁₀/C₁₈-fatty alcohol ethoxylate, 7 EO (100% a.m.) | 1.6 |
| | (Genapol ® C070) | |
| B) | N,N-bis(2-hydroxyethyl)cocoamine oxide | 1.0 |
| C) | Propylene glycol n-butyl ether (Dowanol PnB ®) | 3.0 |
| D) | Water | ad 100 |
| E) | Fragrance | q.s. |
| F) | Dye | q.s. |
| G) | Preservative | q.s. |

Preparation Method:

I Mixing of A and D at room temperature with stirring

II Addition of B to I with stirring

III Addition of C to II with stirring

IV Addition of E, F and G to III with stirring

Example 4-All-purpose cleaner

| | | % by wt. |
|---|---|---|
| A) | C₁₄/C₁₇-sec-alkanesulfonate, Na (60% a.m.) | 2.6 |
| | (Hostapur ® SAS 60) | |
| B) | N,N-bis(2-hydroxyethyl)cocoamine oxide | 1.0 |
| C) | Propylene glycol n-butyl ether (Dowanol PnB ®) | 3.0 |
| D) | Water | ad 100 |
| E) | Fragrance | q.s. |
| F) | Dye | q.s. |
| G) | Preservative | q.s. |

Preparation Method:

I Mixing of A and D at room temperature with stirring

II Addition of B to I with stirring

III Addition of C to II with stirring

IV Addition of E, F and G to III with stirring

Example 5-All-purpose cleaner

| | | % by wt. |
|---|---|---|
| A) | C₁₀/₁₈-fatty alcohol ethoxylate, 7 EO (100 % a.m.) | 0.4 |
| | (Genapol ® C070) | |
| B) | N,N-bis(2-hydroxyethyl)cocoamine oxide | 1.5 |
| C) | C₁₄/C₁₇-sec-alkanesulfonate, Na (60% a.m.) | 0.8 |
| | (Hostapur ® SAS 60) | |
| D) | Propylene glycol n-butyl ether (Dowanol PnB ®) | 3.0 |
| E) | Water | ad 100 |
| F) | Fragrance | q.s. |
| G) | Dye | q.s. |
| H) | Preservative | q.s. |

Preparation Method:

I Addition of A to E at room temperature with stirring

II Addition of B and C to I with stirring

III Addition of D to II with stirring

IV Addition of F, G and H to III with stirring

Example 6-All-purpose cleaner

| | | % by wt. |
|---|---|---|
| A) | N,N-bis(2-hydroxyethyl)cocoamine oxide | 1.0 |
| B) | Ethanol | 2.5 |
| C) | Nipacide BIT 20 | 0.4 |
| D) | Water | ad 100 |
| E) | Dye | q.s. |
| F) | Fragrance | q.s. |

Preparation Method:

Succesive addition of A, B, C, E and F to D at room temperature with stirring

Example 7-Hard Surface Cleaner Gel with bleach

| | | % by wt. |
|---|---|---|
| A) | C₁₀/C₁₈-fatty alcohol ethoxylate, 7 EO (100% a.m.) | 6.7 |
| | (Genapol ® C070) | |
| B) | N,N-bis(2-hydroxyethyl)cocoamine oxide | 0.4 |
| C) | Sodium carbonate | 0.8 |
| D) | H₂O₂ | 6.2 |
| E) | Tripolyphosphate, Na | 0.3 |
| F) | Ammonium acryloyldimethyltaurate/VP copolymer | 0.4 |
| | (Aristoflex ® AVC) | |
| G) | Water | ad 100 |
| H) | Fragrance | q.s. |
| J) | Dye | q.s. |

Preparation Method:

I Succesive addition of A, B and E to G at room temperature with stirring

II Addition of C and D to I with stirring

III Addition of F to II with stirring

IV Addition of H and J to III with stirring

Example 8-Acidic bath cleaner

| | | % by wt. |
|---|---|---|
| A) | C₁₀/C₁₈-fatty alcohol ethoxylate, 7 EO (100% a.m.) | 4.0 |
| | (Genapol ® C070) | |
| B) | N,N-bis(2-hydroxyethyl)cocoamine oxide | 1.0 |
| C) | C₁₄/C₁₇-sec-alkanesulfonate, Na (60% a.m.) | 1.7 |
| | (Hostapur ® SAS 60) | |
| D) | Propylene glycol n-butyl ether (Dowanol PnB ®) | 3.0 |
| E) | Polyacrylate (Sokalan CP 45) | 2.0 |
| F) | Lactic acid | 0.3 |
| G) | Ammonium acryloyldimethyltaurate/VP copolymer | 2.0 |
| | (Aristoflex ® AVC) | |
| H) | Water | ad 100 |
| J) | Fragrance | q.s. |
| K) | Dye | q.s. |

Preparation Method:

I Succesive addition of A, B, C, D, E and F to H at room temperature with stirring

II Addition of G to I with stirring

III Addition of J and K to II with stirring

Example 9-Acidic bath cleaner

| | | % by wt. |
|---|---|---|
| A) | N,N-bis(2-hydroxyethyl)cocoamine oxide | 0.5 |
| B) | Lactic acid | 3.0 |
| C) | Dipropylene glycol n-propyl ether | 4.0 |
| D) | Water | ad 100 |
| E) | Dye | q.s. |
| F) | Fragrance | q.s. |

Preparation Method:

Successive addition of A, B, C, E and F to D at room temperature with stirring

Example 10-Acidic cleaner (pH <5), clear

| | | % by wt. |
|---|---|---|
| A) | C₁₂C₁₈-fatty alcohol ethoxylate, 7 EO (100% a.m.) | 1.2 |
| | (Genapol ® LA070) | |
| B) | N,N-bis(2-hydroxyethyl)cocoamine oxide | 0.6 |
| C) | C₁₄/C₁₇-sec-alkanesulfonate, Na (60% a.m.) | 6.5 |
| | (Hostapur ® SAS 60) | |
| D) | Citric acid | 18.0 |
| E) | Sodium chloride | 2.4 |
| F) | Ammonium acryloyldimethyltaurate/VP copolymer | 1.0 |
| | (Aristoflex ® AVC) | |
| G) | Water | ad 100 |

Preparation Method:

I Successive addition of A, B, C, D to G at room temperature with stirring

II Addition of E and F to I with stirring

Example 11-Pasty cleaning composition

| | | % by wt. |
|---|---|---|
| A) | N,N-bis(2-hydroxyethyl)cocoamine oxide | 18.5 |
| B) | Polyethylene glycol 450 | 49.0 |
| C) | Preservative | 0.04 |
| D) | Water | ad 100 |
| E) | Dye | q.s. |
| F) | Fragrance | q.s. |

Preparation Method:

I Successive addition of A, B and C to D at room temperature with stirring

II Addition of E and F to I with stirring

Example 12-Disinfectant

| | | % by wt. |
|---|---|---|
| A) | N,N-bis(2-hydroxyethyl)cocoamine oxide | 0.5 |
| B) | C_{12/14}-alkyldimethylbenzylammonium | 0.2 |
| | chloride | |
| C) | Preservative | 0.04 |
| D) | Water | ad 100 |
| E) | Dye | q.s. |
| F) | Fragrance | q.s. |

Preparation Method:

I Successive addition of A, B and C to D at room temperature with stirring

II Addition of E and F to I with stirring

III Adjustment of the pH to 10 with NaOH

The disinfectant can be used as liquid or even in sprayable form.

1. A method for the cleaning of lime-containing soil from a hard surface, wherein the hard surface is selected from the group consisting of ceramic, metal, wood, glass and plastic, comprising the step of contact the hard surface with a composition comprising N,N-bis(2-hydroxyethyl)cocoamine oxide.

2. A method as claimed in claim 1, wherein the lime-containing soil comprises 5 to 100% by weight of lime.

3. A method as claimed in claim 1, wherein the composition comprises from 0.1 to 20% by weight of N,N-bis(2-hydroxyethyl)cocoamine oxide.

4. A method as claimed in claim 1, wherein the composition comprises from 0.3 to 1.5% by weight of N,N-bis(2-hydroxyethyl)cocoamine oxide.

5. A method as claimed in claim 1, wherein the composition is liquid at room temperature.

6. A method as claimed in claim 5, wherein the composition is present in sprayable form.

7. A method as claimed in claim 1, wherein the composition is solid or pasty at room temperature.

8. A method as claimed in claim 5, wherein the liquid composition has a pH≦5.

9. A method as claimed in claim 1, wherein the composition further comprises at least one substance selected from the group consisting of disinfectant and bleach.

10. A method as claimed in claim 1, wherein the composition is phosphate-free.

11. A method as claimed in claim 7, wherein the solid or pasty composition dissolved in water has a pH of pH≦5.
